(19) United States
(12) Patent Application Publication
(10) Pub. No.: US 2025/0201490 A1
(43) Pub. Date: Jun. 19, 2025

(54) TANTALUM CAPACITOR AND BOARD HAVING TANTALUM CAPACITOR MOUNTED THEREON

(71) Applicant: SAMSUNG ELECTRO-MECHANICS CO., LTD., Suwon-si (KR)

(72) Inventors: Dong Hyeon LEE, Suwon-si (KR); Seok Hwan KIM, Suwon-si (KR)

(73) Assignee: SAMSUNG ELECTRO-MECHANICS CO., LTD., Suwon-si (KR)

(21) Appl. No.: 18/949,081

(22) Filed: Nov. 15, 2024

(30) Foreign Application Priority Data
Dec. 14, 2023 (KR) 10-2023-0181811

(51) Int. Cl. H01G 9/052; H01G 2/06; H01G 9/04; H01G 9/14

(52) U.S. Cl. CPC H01G 9/0525; H01G 2/06; H01G 9/14; H01G 2009/05

(57) ABSTRACT

A tantalum capacitor includes a tantalum body including a tantalum element including tantalum powder, and a tantalum wire passing through at least a portion of the tantalum element in a first direction, a molded portion having fifth and sixth surfaces opposing each other in the first direction, third and fourth surfaces opposing each other in a second direction, first and second surfaces opposing each other in a third direction, the molded portion formed to surround the tantalum body, an anode lead frame connected to the tantalum wire, a cathode lead frame spaced apart from the anode lead frame, the cathode lead frame connected to the tantalum body, and a frame terminal disposed on the anode lead frame and the cathode lead frame to be spaced apart from the second surface of the molded portion.

### CROSS-REFERENCE TO RELATED APPLICATION(S)

This application claims benefit of priority to Korean Patent Application No. 10-2023-0181811 filed on Dec. 14, 2023 in the Korean Intellectual Property Office, the disclosure of which is incorporated herein by reference in its entirety.

### TECHNICAL FIELD

The present disclosure relates to a tantalum capacitor and a board having the tantalum capacitor mounted thereon, and more specifically, to a tantalum capacitor having improved reliability against drops and impacts and a board having the tantalum capacitor mounted thereon.

Tantalum (Ta) is a metal widely used across industries, including in the electricity and electronics, machinery, chemical engineering, medicine, space, and military industries, due to mechanical and physical characteristics thereof, such as high melting point, excellent ductility and corrosion resistance.

In particular, tantalum has been widely used as a positive electrode material for small-sized capacitors due to characteristics thereof which form the most stable anodized film, among all metals.

Moreover, the use of a tantalum material has rapidly increased annually, due to the recent rapid development of IT industries, such as electronics, information and communication, and the like.

Tantalum capacitors may have a structure using an internal lead frame to connect a tantalum body and an electrode to each other. When a drop impact is applied, an internal lead frame and a molded portion may be separated from each other, and thus a chip may fall off. In terms of product reliability, detachment of the chip may be a fatal defect.

### SUMMARY

An aspect of the present disclosure tantalum capacitor having improved reliability against drops and impacts and a board having the tantalum capacitor mounted thereon.

According to an aspect of the present disclosure, there is provided a tantalum capacitor including a tantalum body including a tantalum element including tantalum particles, and a tantalum wire passing through at least a portion of the tantalum element in a first direction, a molded portion having fifth and sixth surfaces opposing each other in the first direction, third and fourth surfaces opposing each other in a second direction, and first and second surfaces opposing each other in a third direction, the molded portion surrounding the tantalum body, a anode lead frame connected to the tantalum wire, a cathode lead frame spaced apart from the anode lead frame, the cathode lead frame connected to the tantalum body, and a frame terminal disposed on the anode lead frame and the cathode lead frame to be spaced apart from the second surface of the molded portion.

According to another aspect of the present disclosure, there is provided a tantalum capacitor including a tantalum body including a tantalum element including tantalum particles, and a tantalum wire passing through at least a portion of the tantalum element in a first direction, a molded portion having fifth and sixth surfaces opposing each other in the first direction, third and fourth surfaces opposing each other in a second direction, and first and second surfaces opposing each other in a third direction, the molded portion surrounding the tantalum body, a anode lead frame connected to the tantalum wire, a cathode lead frame spaced apart from the anode lead frame, the cathode lead frame connected to the tantalum body, and a frame terminal having at least a portion protruding from the molded portion, the frame terminal disposed on the anode lead frame and the cathode lead frame, wherein at least a portion of the second surface of the molded portion is externally exposed.

According to example embodiments of the present disclosure, a tantalum capacitor having improved reliability against drops and impacts and a board having the tantalum capacitor mounted thereon may be provided.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a tantalum capacitor according to the present disclosure;

FIG. 2 is a diagram illustrating a tantalum capacitor viewed in a second direction according to the present disclosure;

FIG. 3 is a diagram illustrating a tantalum capacitor viewed in a first direction according to the present disclosure;

FIG. 4 is a cross-sectional view taken along line I-I′ in FIG. 1;

FIGS. 5A to 5B are diagrams illustrating stress distribution when a tantalum capacitor according to the related art and a tantalum capacitor according to the present disclosure, respectively, are dropped; and

FIG. 6 is a perspective view of a printed circuit board on which a tantalum capacitor is mounted according to the present disclosure.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Hereinafter, preferred example embodiments of the present disclosure will be described with reference to the accompanying drawings.

In the drawings, an X-direction may be defined as a first direction, an L-direction, or a length direction, a Y-direction may be defined as a second direction, a W direction, or a width direction, and a Z-direction may be defined as a third direction, a T-direction, or a thickness direction.

### (Tantalum Capacitor)

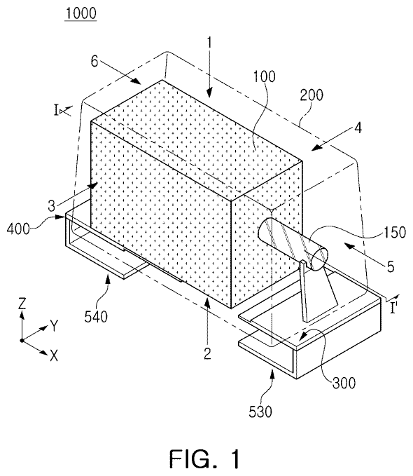

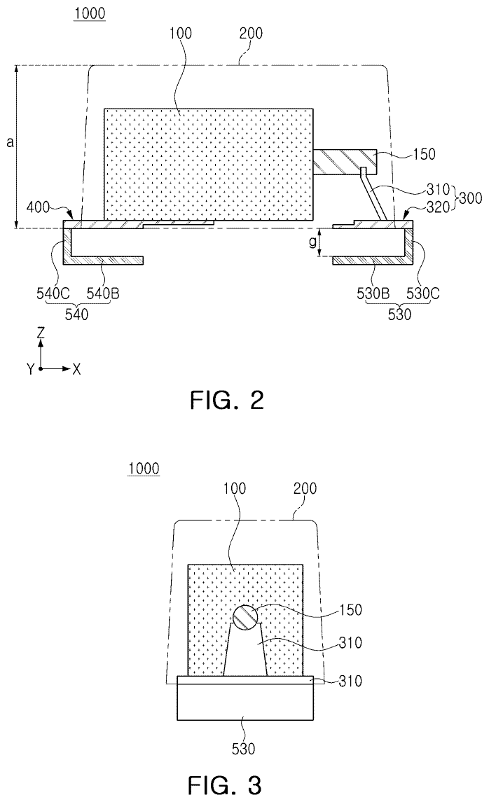

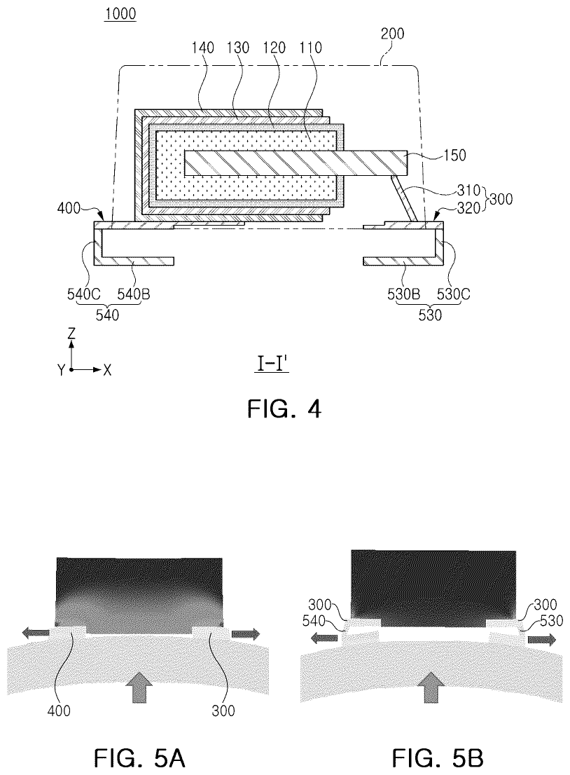

FIG. 1 is a perspective view of a tantalum capacitor according to the present disclosure. FIG. 2 is a diagram illustrating a tantalum capacitor viewed in a second direction according to the present disclosure. FIG. 3 is a diagram illustrating a tantalum capacitor viewed in a first direction according to the present disclosure. FIG. 4 is a cross-sectional view taken along line I-I′ in FIG. 1.

Referring to FIGS. 1 and 2, a tantalum capacitor 1000 according to the present example embodiment may include a tantalum body 100 including a tantalum element 110 including tantalum powder, and a tantalum wire 150 passing through at least a portion of the tantalum element in a first direction (X-direction), a molded portion 200 having fifth and sixth surfaces 5 and 6 opposing each other in the first direction (X-direction), third and fourth surfaces 3 and 4 opposing each other in a second direction (Y-direction), and first and second surfaces 1 and 2 opposing each other in a third direction (Z-direction), the molded portion 200 formed to surround the tantalum body 100, a anode lead frame 300 extending to the second surface 2 of the molded portion 200, the anode lead frame 300 electrically connected to the tantalum wire 150, a cathode lead frame 400 spaced apart from the anode lead frame 300, the cathode lead frame 400 extending to the second surface 2 of the molded portion 200, and a frame terminal 500 disposed on the anode lead frame 300 and the cathode lead frame 400.

The tantalum body 100 may have the tantalum wire 150 exposed in the first direction (X-direction) of the tantalum body 100. Here, the tantalum wire 150 may pass through at least a portion of the tantalum element 110 in the first direction (X-direction). The tantalum wire 150 may be inserted into and installed in a mixture of tantalum powder and a binder to be off-centered before the mixture of the tantalum powder and the binder is compressed. That is, the tantalum body 100 may be manufactured by insertedly installing the tantalum wire 150 in the tantalum powder mixed with the binder, forming a tantalum element having a desired size, and then sintering the tantalum element in a high temperature and high vacuum (10⁻⁵ torr or less) atmosphere for about 30 minutes.

The molded portion 200 may be formed to cover the tantalum body 100, and to expose one surface of a first connection portion 320 of the anode lead frame 300 and one surface of the cathode lead frame 400.

The molded portion 200 of the tantalum capacitor according to the present disclosure may be formed by transfer-molding a resin, such as an epoxy molding compound (EMC) or the like, to surround the tantalum body 100. The molded portion 200 may serve to protect the tantalum wire 150 and the tantalum body 100 from outside.

The anode lead frame 300 may be connected to the tantalum wire 150 to serve as a terminal when mounted on a board. The anode lead frame 300 may include the first connection portion 320 and a first bent portion 310, and the first bent portion 310 may be inclined toward the tantalum body 100 with respect to the first connection portion 320. The first connection portion 320 of the anode lead frame 300 may be exposed to the second surface 2 and the fifth surface 5 of the molded portion 200, but the present disclosure is not limited thereto. The first connection portion 320 may be positioned further inwardly than a lower surface of the molded portion 200 and recessed in the molded portion 200. The first connection portion 320 may be connected to a anode frame terminal 530 to be described below, and the first connection portion 320 may be exposed to the lower surface of the molded portion 200 to serve as a terminal when mounted on the board. Here, the first connection portion 320 may be spaced apart from the tantalum body 100, and may function as a positive electrode of the tantalum capacitor 1000 according to the present disclosure. To this end, the anode lead frame 300 may be formed of a conductive metal, such as a nickel/iron alloy or the like.

The cathode lead frame 400 may be connected to the tantalum body 100 to serve as a terminal when mounted on the board. The cathode lead frame 400 may be spaced apart from the anode lead frame 300 to be parallel to the anode lead frame 300 in the first direction (X-direction). The cathode lead frame 400 may be exposed to the second surface 2 and the sixth surface 6 of the molded portion 200. However, the present disclosure is not necessarily limited thereto, and the cathode lead frame 400 may be positioned further inwardly than a lower surface of the molded portion 200 and recessed in the molded portion 200. The cathode lead frame 400 may be connected to a cathode frame terminal 540 to be described below, and the cathode frame terminal 540 may be exposed to the lower surface of the molded portion 200 to serve as a terminal when mounted on the board. That is, the cathode lead frame 400 may function as a negative electrode of the tantalum capacitor 1000 according to the present disclosure, together with the cathode frame terminal 540. To this end, the cathode lead frame 400 may be formed of a conductive metal such as a nickel/iron alloy or the like.

FIG. 4 is a cross-sectional view taken along line I-I′ in FIG. 1.

Referring to FIG. 4, the tantalum body 100 of the tantalum capacitor 1000 according to an example embodiment of the present disclosure may include the tantalum element 110 formed by sintering a molded body including metal powder, a conductive polymer layer 120 disposed on an upper portion of the tantalum element 110, a carbon layer 130 disposed on the conductive polymer layer 120, and a silver (Ag) layer 140 disposed on the carbon layer 130.

The tantalum capacitor may further include the tantalum wire 150 having an insertion region positioned on the inside of the tantalum element 110, and a non-insertion region positioned on the outside of the tantalum element 110.

The tantalum element 110 may be formed by sintering a molded body including metal powder and a binder.

Specifically, the tantalum element 110 may be manufactured by mixing metal powder, a binder, and a solvent at a predetermined ratio, stirring mixed powder, compressing the mixed powder to form the mixed powder to have a rectangular parallelepiped shape, and then sintering the same under high temperature and high vibration.

The metal powder is not limited as long as it may be used in the tantalum element 110 of the tantalum capacitor 1000 according to an example embodiment in the present disclosure, and may be tantalum (Ta) powder. However, the present disclosed is not limited thereto, the metal powder may be one or more selected from the group consisting of aluminum (Al), niobium (Nb), vanadium (V), titanium (Ti), and zirconium (Zr), and accordingly, an aluminum element, a niobium element, or the like may also be used, instead of a tantalum body.

The binder is not limited, and may be, for example, a cellulose-based binder.

The cellulose-based binder may be one or more selected from the group consisting of nitrocellulose, methyl cellulose, ethyl cellulose, and hydroxy propyl cellulose.

In addition, the tantalum wire 150 may be inserted into and installed in the mixed powder to be off-centered, before the mixed powder is compressed.

According to an example embodiment of the present disclosure, a dielectric oxide layer may be formed on the tantalum element 110, as an insulating layer. That is, the dielectric oxide layer may be formed by growing an oxide film (Ta₂O₅) on a surface of the tantalum element 110 through a formation process using an electrochemical reaction. Here, the dielectric oxide layer may change the tantalum element 110 into a dielectric. In addition, the conductive polymer layer 120 having a negative polarity may be coated and formed on the dielectric oxide layer.

The conductive polymer layer 120 is not limited, and may include, for example, a conductive polymer.

Specifically, the conductive polymer may be formed using chemical polymerization or electrolytic polymerization using 3,4-ethylenedioxythiophene (EDOT), a pyrrole monomer, or polypyrrole, and may then be formed on an external surface of the tantalum element 110 formed as an insulating layer, as a negative electrode layer having a conductive polymer negative electrode.

That is, the conductive polymer layer 120 may be formed using a polymer slurry, and the polymer slurry may include at least one of polypyrrole, polyaniline, or 3,4-ethylenedioxythiophene (EDOT). In addition, the conductive polymer layer 120 may include poly(3,4-ethylenedioxythiophene):poly(styrenesulfonate)(PEDOT:PSS). PEDOT:PSS may be prepared by oxidative polymerization of EDOT using polystyrene sulfonate (PSS) as a template for balancing an electric charge.

The carbon layer 130 may be laminated on the conductive polymer layer 120, and may be laminated by dissolving carbon powder in an organic solvent including an epoxy resin, impregnating the tantalum element 110 in the solution in which the carbon powder is dissolved, and then, perform drying thereon at a predetermined temperature to volatilize the organic solvent.

In addition, the carbon layer 130 may serve to prevent silver (Ag) ions from passing therethrough.

Next, the silver (Ag) layer 140, formed of silver (Ag) paste, may be included on an upper surface of the carbon layer 130.

The silver (Ag) layer 140 may be laminated on the outside of the carbon layer 130 to improve conductivity.

In addition, the silver (Ag) layer 140 may improve conductivity with respect to a polarity of a negative electrode layer, thereby facilitating electrical connection for polarity transfer.

Referring to FIGS. 2 and 3, a frame terminal 500 will be described in detail.

The tantalum capacitor according to the present disclosure may include a frame terminal 500, disposed on the anode lead frame 300 and the cathode lead frame 400.

The anode lead frame 300 and the cathode lead frame 400 may be exposed to a lower surface (second surface 2) of the molded portion 200, and the frame terminal 500 may be disposed below the anode lead frame 300 and the cathode lead frame 400. Specifically, the frame terminal 500 may include a anode frame terminal 530 connected to the anode lead frame 300, and a cathode frame terminal 540 connected to the cathode lead frame 400.

Hereinafter, descriptions of the anode frame terminal 530 and the cathode frame terminal 540 may substantially overlap each other. Thus, although the anode frame terminal 530 is described for convenience, the same descriptions may be applied to the cathode lead frame terminal 540.

At least a portion of the anode frame terminal 530 may protrude from the molded portion 200. As illustrated in FIG. 2, the anode frame terminal 530 may entirely protrude from the second surface 2 of the molded portion 200. However, when the anode lead frame 300 is recessed further inwardly than the lower surface (second surface, 2) of the molded portion 200, a portion of the anode frame terminal 530 may also be recessed in the molded portion 200.

The anode frame terminal 530 may include a connection portion 530C connected to the anode lead frame 300, and a bent portion 530B extending from the connection portion in a first direction (X-direction). Similarly, the cathode frame terminal 540 may include a connection portion 540C connected to the cathode lead frame 400, and a bent portion 540B extending from the connection portion in the first direction (X-direction).

The bent portion 530B may be bent from the connection portion 530C toward the inside of the tantalum capacitor. Referring to FIG. 2, it may be seen that the bent portion 530B of the anode frame terminal 530 is bent toward the cathode lead frame 400. Similarly, it may be seen that the bent portion 540B of the cathode frame terminal 540 is bent toward the anode lead frame 300. That is, the frame terminal 530 may have a shape of a letter “L.”

The bent portion 530B may be substantially parallel to the lower surface (second surface, 2) of the molded portion 200. This may be because, as will be described below, the bent portion 530B is a portion in contact with an electrode pad when mounted on a printed circuit board.

The anode frame terminal 530 and the lower surface (second surface and 2) of the molded portion may be spaced apart from each other. Specifically, the bent portion 530B and the second surface 2 of the molded portion 200 may be spaced apart from each other. That is, a gap may be formed between the bent portion 530B and the molded portion 200. The lower surface (second surface and 2) of the molded portion may not be in contact with other components of the tantalum capacitor, and accordingly, at least a portion of the lower surface (second surface and 2) of the molded portion may be externally exposed.

The anode frame terminal 530 and the anode lead frame 300 may be spaced apart from each other. Specifically, the anode frame terminal 530 and the first connection portion 320 of the anode lead frame may be spaced apart from each other.

In a tantalum capacitor not having a frame terminal according to the related art, when drop impact is applied, direct stress may be applied to lead frames 300 and 400, causing deformation between the lead frames 300 and 400. As a result, the lead frames 300 and 400 and the molded portion 200 may be separated from each other, and thus a chip may fall off. In terms of product reliability, detachment of the chip may be a fatal defect.

In the tantalum capacitor 1000 according to the present disclosure, the frame terminal 500 may be further disposed on the lead frames 300 and 400, thereby preventing concentration of stress. FIGS. 5A and 5B are diagrams illustrating stress distribution when a tantalum capacitor according to the related art and a tantalum capacitor according to the present disclosure, respectively, are dropped. Referring to FIG. 5A, it may be seen that stress transferred to the outside of the tantalum capacitor is greater than stress transferred to the other portions of the tantalum capacitor, due to bending of a printed circuit board when the tantalum capacitor is dropped. When the frame terminal 500 including a bent portion is disposed on the outside of the tantalum capacitor, specifically, on the lead frames 300 and 400 (FIG. 5B, such concentration of stress may be prevented, and as a result, stress directly transferred to the tantalum capacitor may be reduced.

When a distance between the anode frame terminal 530 and the anode lead frame 300 is denoted by g, and a length of the molded portion 200 in a third direction (Z-direction) is denoted by a, g/a may satisfy 0.1 or more and 0.3 or less.

A distance between the cathode frame terminal 540 and the cathode lead frame 400 may be substantially the same as a distance g between the anode frame terminal 530 and the anode lead frame 300. Similarly, the above-described relationship may be satisfied.

[Table 1] below illustrates an effect of reducing stress according to a change of g/a. Specifically, a stress reduction ratio and whether an actual product is implementable were measured in experimental examples in which a distance (g) between the frame terminals 530 and 540 and the lead frames 300 and 400 varies while a length (a) of the molded portion 200 in the third direction (Z-direction) is maintained, and a comparative example in which no frame terminals 530 and 540 are formed.

TABLE 1

| | | | | | Whether |
|---|---|---|---|---|---|
| | | | | Stress | actual |
| | | | | reduction | product is |
| Division | g[mm] | a[mm] | g/a | ratio [%] | implementable |
| Comparative | — | 2.0 | 0 | 0 | ◯ |
| Example | | | | | |
| Experimental | 0.2 | 2.0 | 0.1 | 47 | ◯ |
| Example 1 | | | | | |
| Experimental | 0.4 | 2.0 | 0.2 | 60 | ◯ |
| Example 2 | | | | | |
| Experimental | 0.6 | 2.0 | 0.3 | 71 | ◯ |
| Example 3 | | | | | |
| Experimental | 0.8 | 2.0 | 0.4 | 76 | X |
| Example 4 | | | | | |
| Experimental | 1.0 | 2.0 | 0.5 | 81 | X |
| Example 5 | | | | | |

Referring to Table 1 above, it may be seen that, in the comparative example, stress decreases as a size (length) of the gap (g) increases. However, when the size (length) of the gap (g) excessively increases, a height of a product may be excessively increase, as compared to a stress reduction effect, making it difficult to actually manufacture and use the product.

Accordingly, in the present disclosure, a parameter g/a representing a relationship between length g and a may be defined. When g/a is 0.1 or more and 0.3 or less, stress, directly transferred from the printed circuit board to the tantalum capacitor during drops and impacts, may be reduced. At the same time, miniaturization and implementation of capacitance of the tantalum capacitor may be simultaneously achieved.

The distance g between the frame terminals 530 and 540 and the lead frames 300 and 400 may be obtained by measuring a distance between the bent portions 530B and 540C and the lead frames 300 and 400.

The distance g can be obtained by measuring a length along the third direction (Z direction). When measuring the length a plurality of times, g may refer to an average of values obtained by measuring the length a plurality of times, and specifically, may mean an arithmetic average. For example, when the length is measured at 5 points by varying a position for measurement, g may be an arithmetic average of values obtained by measuring the length. Likewise, the same explanation can be applied to length ‘a’. The distance g and the length a may be measured using an optical microscope. Other methods and/or tools appreciated by one of ordinary skill in the art, even if not described in the present disclosure, may also be used.

The frame terminals 530 and 540 may be formed of a material, the same as a material of the anode lead frame 300 and the cathode lead frame 400. Specifically, the frame terminals 530 and 540 may be formed of a conductive metal such as a nickel/iron alloy or the like. More specifically, the frame terminals 530 and 540 may be formed of EFTEC-64T, SUS304, Alloy 42, or the like. However, the present disclosure is not limited thereto, and the frame terminals 530 and 540 may be formed of a material different from the material of the anode lead frame 300 and the material of the cathode lead frame 400.

Although not illustrated in the drawings, the tantalum capacitor according to an example embodiment of the present disclosure may further include a conductive adhesive layer to bond the frame terminals 530 and 540 to the anode lead frame 300 and the cathode lead frame 400.

The conductive adhesive layer may be disposed between the frame terminals 530 and 540 and the anode lead frame 300 and the cathode lead frame 400 to bond the frame terminals 530 and 540 to the anode lead frame 300 and the cathode lead frame 400.

The conductive adhesive layer may be a solder. Specifically, a solder, such as a Sn—Sb-based solder, a Sn—Ag—Cu-based solder, a Sn—Cu-based solder, a Sn—Bi-based solder, or the like, may be used. Alternatively, the conductive adhesive layer may be formed by coating and curing a predetermined amount of a conductive adhesive including an epoxy-based thermosetting resin and conductive metal powder such as silver (Ag), but the present disclosure is not limited thereto.

### (Board Having Tantalum Capacitor Mounted Thereon)

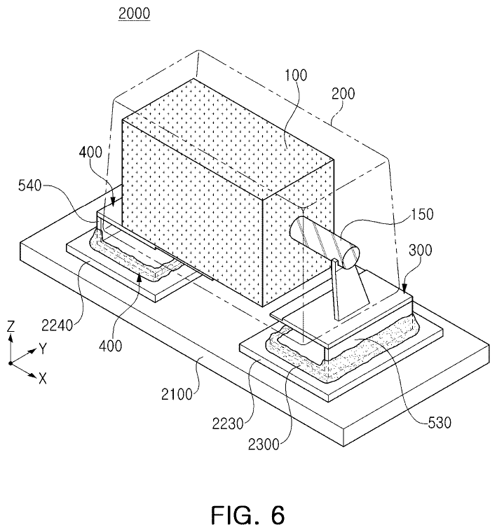

FIG. 6 is a perspective view of a board 2000 on which a tantalum capacitor is mounted according to the present disclosure.

Referring to FIG. 6, a board 2000 having a tantalum capacitor mounted thereon according to the present example embodiment may include a printed circuit board 2100 having a plurality of electrode pads 2230 and 2240, the tantalum capacitor 1000 described above, and a solder 2300 connecting the electrode pads and the tantalum capacitor to each other.

The tantalum capacitor 1000 may be electrically connected to the printed circuit board 2100 by the solder 2300 in a state in which the bent portions 530B and 540B of the frame terminals 530 and 540 are mounted on the plurality of electrode pads 2230 and 2240 to be connected to the plurality of electrode pads 2230 and 2240, respectively.

The tantalum capacitor 1000 may be used while being mounted on the printed circuit board, as illustrated in FIG. 6. As described above in connection with the tantalum capacitor 1000, stress, directly transferred from the printed circuit board to the tantalum capacitor during drops and impacts, may be reduced.

While example embodiments have been shown and described above, it will be apparent to those skilled in the art that modifications and variations could be made without departing from the scope of the present disclosure as defined by the appended claims.

What is claimed is:

1. A tantalum capacitor comprising:
a tantalum body including a tantalum element including tantalum particles, and a tantalum wire passing through at least a portion of the tantalum element in a first direction;
a molded portion having fifth and sixth surfaces opposing each other in the first direction, third and fourth surfaces opposing each other in a second direction, and first and second surfaces opposing each other in a third direction, the molded portion surrounding the tantalum body;
an anode lead frame connected to the tantalum wire;
a cathode lead frame spaced apart from the anode lead frame, the cathode lead frame connected to the tantalum body; and
a frame terminal disposed on the anode lead frame and the cathode lead frame to be spaced apart from the second surface of the molded portion.

2. The tantalum capacitor of claim 1, wherein the frame terminal includes a connection portion connected to the anode lead frame and the cathode lead frame, and a bent portion extending from the connection portion in the first direction.

3. The tantalum capacitor of claim 2, wherein the bent portion is bent toward an inside of the tantalum capacitor from the connection portion.

4. The tantalum capacitor of claim 2, wherein the bent portion and the second surface of the molded portion are spaced apart from each other.

5. The tantalum capacitor of claim 2, wherein the connection portion extends from the anode lead frame in the third direction, and the connection portion does not overlap the molded portion.

6. The tantalum capacitor of claim 1, wherein the frame terminal has an “L” shape.

7. The tantalum capacitor of claim 1, wherein, when a distance between the frame terminal and the anode lead frame is denoted by g, and a length of the molded portion in the third direction is denoted by a, g/a satisfies 0.1 or more and 0.3 or less.

8. The tantalum capacitor of claim 1, wherein each of the frame terminal, the anode lead frame, and the cathode lead frame includes the same material.

9. The tantalum capacitor of claim 1, wherein the tantalum body further includes:
a conductive polymer layer disposed on the tantalum element;
a carbon layer disposed on the conductive polymer layer; and
a silver (Ag) layer disposed on the carbon layer.

10. The tantalum capacitor of claim 1, wherein at least a portion of the frame terminal protrudes from the second surface of the molded portion.

11. The tantalum capacitor of claim 1, further comprising:
a conductive adhesive layer disposed between the frame terminal and the anode lead frame and the cathode lead frame.

12. A tantalum capacitor comprising:
a tantalum body including a tantalum element including tantalum particles, and a tantalum wire passing through at least a portion of the tantalum element in a first direction;
a molded portion having fifth and sixth surfaces opposing each other in the first direction, third and fourth surfaces opposing each other in a second direction, and first and second surfaces opposing each other in a third direction, the molded portion surrounding the tantalum body;
a anode lead frame connected to the tantalum wire;
a cathode lead frame spaced apart from the anode lead frame, the cathode lead frame connected to the tantalum body; and
a frame terminal having at least a portion protruding from the molded portion, the frame terminal disposed on the anode lead frame and the cathode lead frame,
wherein at least a portion of the second surface of the molded portion is externally exposed.

13. The tantalum capacitor of claim 12, wherein the frame terminal includes a connection portion connected to the anode lead frame and the cathode lead frame, and a bent portion extending from the connection portion in the first direction.

14. The tantalum capacitor of claim 12, wherein the frame terminal and the second surface of the molded portion are spaced apart from each other.

15. The tantalum capacitor of claim 14, wherein, when a distance between the frame terminal and the anode lead frame is denoted by g, and a length of the molded portion in the third direction is denoted by a, g/a satisfies 0.1 or more and 0.3 or less.

16. A board, comprising:
a printed circuit board having a plurality of electrode pads on an upper portion of the printed circuit board;
the tantalum capacitor of claim 1 installed on the printed circuit board; and
a solder connecting the plurality of electrode pads and the tantalum capacitor to each other.

17. The board of claim 16, wherein the solder is connected to the frame terminal of the tantalum capacitor.

18. The board of claim 17, wherein the frame terminal is disposed between the anode lead frame and the solder.

19. The board of claim 18, wherein the anode lead frame includes a first connection portion and a first bent portion, wherein the first bent portion inclines toward the tantalum body.
